(19) United States
(12) Patent Application Publication
(10) Pub. No.: US 2008/0162836 A1
(43) Pub. Date: Jul. 3, 2008

(54) Staggered interleaved memory access

(76) Inventors: Roy D. Wojciechowski, Round Rock, TX (US); Asad Khan, Dallas, TX (US)

Correspondence Address: TEXAS INSTRUMENTS INCORPORATED, P O BOX 655474, M/S 3999, DALLAS, TX, 75265, US

(21) Appl. No.: 11/648,701

(22) Filed: Dec. 29, 2006

(51) Int. Cl. G06F 13/00

(52) U.S. Cl. 711/157

(57) ABSTRACT

Methods and systems are provided for receiving and assembling serial data into parallel arrangements referred to as data slices. A plurality of data slices define a data line. Data slices common to a data line are written across like addresses of memory logically partitioned as memory slots. Respective memory slots are selected for data write operations in a successively advancing manner. As a result, a just-written data slice is immediately available for reading on the next clock cycle. Also, respective data slices can be simultaneously written to and read from the same or different memory slots on a particular clock cycle. Fast serial data communication between peripheral devices and other computer-related entities is performed accordingly.

### BACKGROUND

Certain computer architectures make considerable use of serial data communication, especially between peripheral devices (e.g., video adapter cards, input/output interface cards, etc.) common to a computer device. One such exemplary communications protocol is PCI-Express®, as owned by PCI-SIG Corporation, Portland, Oreg. Under such an environment, it is necessary to receive serial data from a transmitting peripheral device by way of a single input port on a receiving peripheral device. It is further necessary to assemble that serial data into parallel forms (i.e., bytes, words, double-words, etc.) and output that parallel data to respective components and other entities on the receiving peripheral device.

The output parallel data is typically provided by way of multiple “egress ports” on the receiving peripheral, each port corresponding to some final recipient. In this way, transaction layer packets (TLPs), as originally received by way of the incoming serial data, can be simultaneously read from the egress ports. Typically, such overall receive/assemble/output operations are performed by way of wide memory in which a word is periodically written (i.e., fully assembled) and stored for each egress port. Thereafter, a portion of the word is output on every clock cycle.

While the above described method is widely known, it requires a large amount of buffer memory for each egress port and the use of complex management protocols. Other serial data reception and parallel data dissemination systems and methods are desirable.

### SUMMARY

In one embodiment, a memory system has its overall memory width divided into plural slices or slots. In this way, a predetermined number of data slices collectively define a data line that is stored across the width of the overall memory. One data slice is stored per memory slot. Serial data is assembled (i.e., accumulated and arranged) into data slices of plural bits in width. As a first data slice is fully assembled, it is written to a line number (i.e., address) in a first memory slot. The next data slice of that same data line is then assembled and written to the same address in a second memory slot. The first and second memory slots are considered logically adjacent to one another in the overall scheme of the memory system.

This data assemblage and writing process is repeated until the entire data line has been written across the same line number of the plural memory slots. Assemblage and writing of the next data line across the plural memory slots, beginning with another address of the first memory slot, is then performed. In this way, serial data is written to the several memory slots in a successively advancing manner.

For a given egress port, a data line is read one data slice from each memory slot. When the egress port (i.e., receiving component) is ready for the next slice of a particular data line, the next slot is read at the same line number. In this way, entire data slices are read from the memory slots, at the same line (i.e., address), until an entire data line has been output. Reading can then move on to the first memory slot of the next data line. In this way, matching is achieved with respect to the rate that serial data is received and parallel data is delivered to respective egress ports. This serial-input/parallel-output matching is also referred to as “data rate matching”. The egress ports are buffered in a first-in/first-out (i.e., FIFO) manner to enable such data rate matching, especially when parallel data is being read at a lower rate than serial data is being received.

### BRIEF DESCRIPTION OF THE CONTENTS

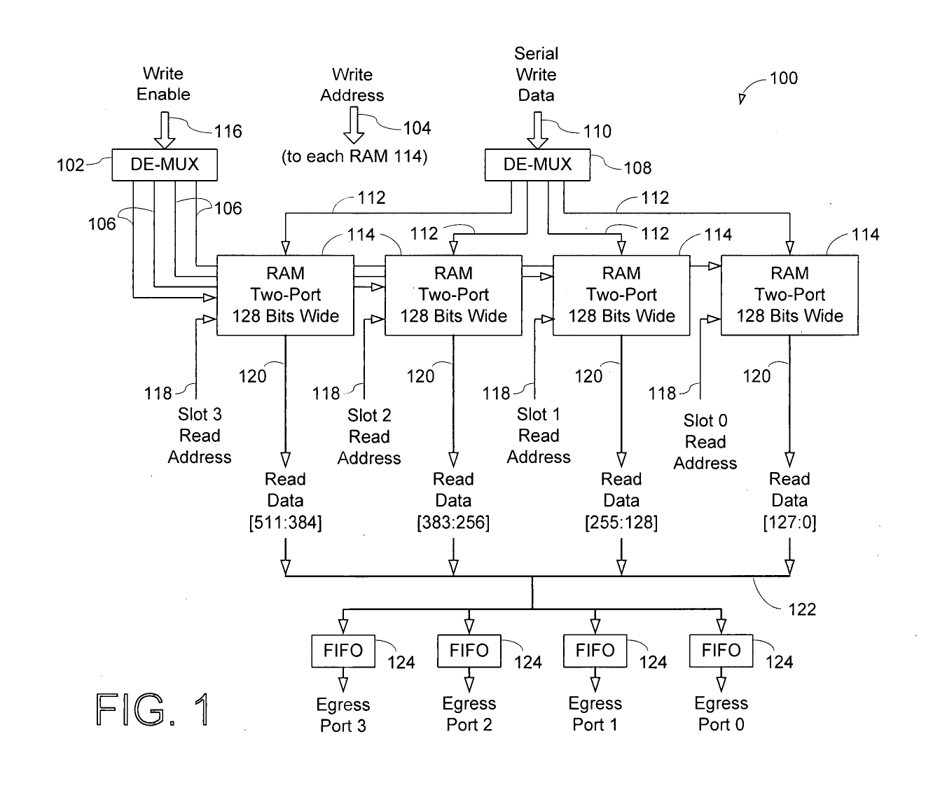

FIG. 1 illustrates an exemplary memory system in accordance with one embodiment.

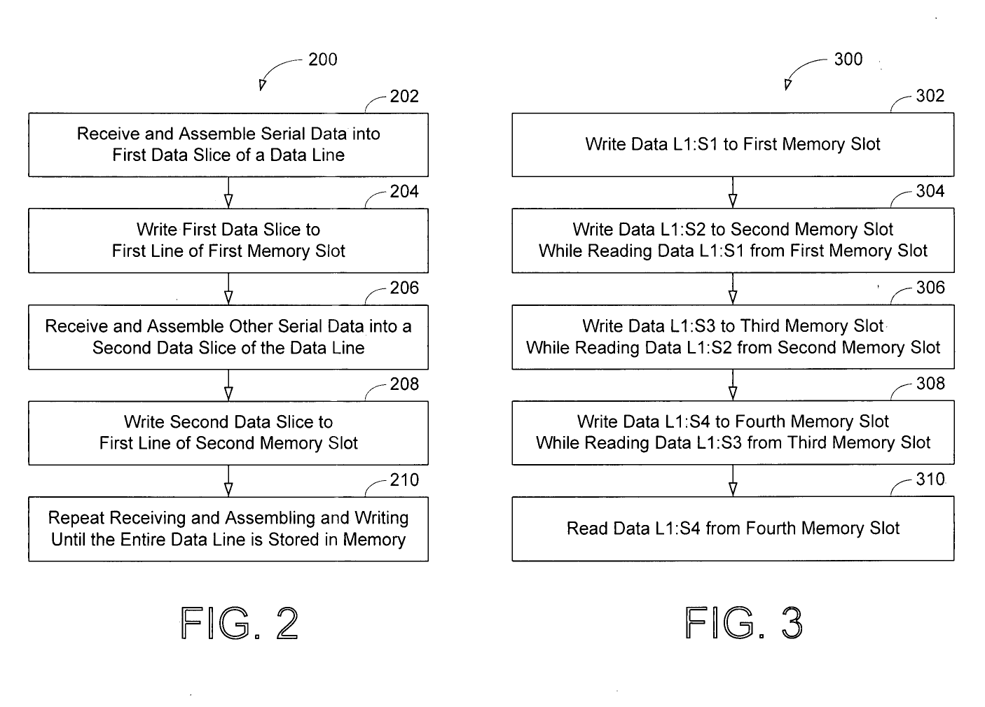

FIG. 2 illustrates method steps in accordance with one embodiment.

FIG. 3 illustrates method steps in accordance with another embodiment.

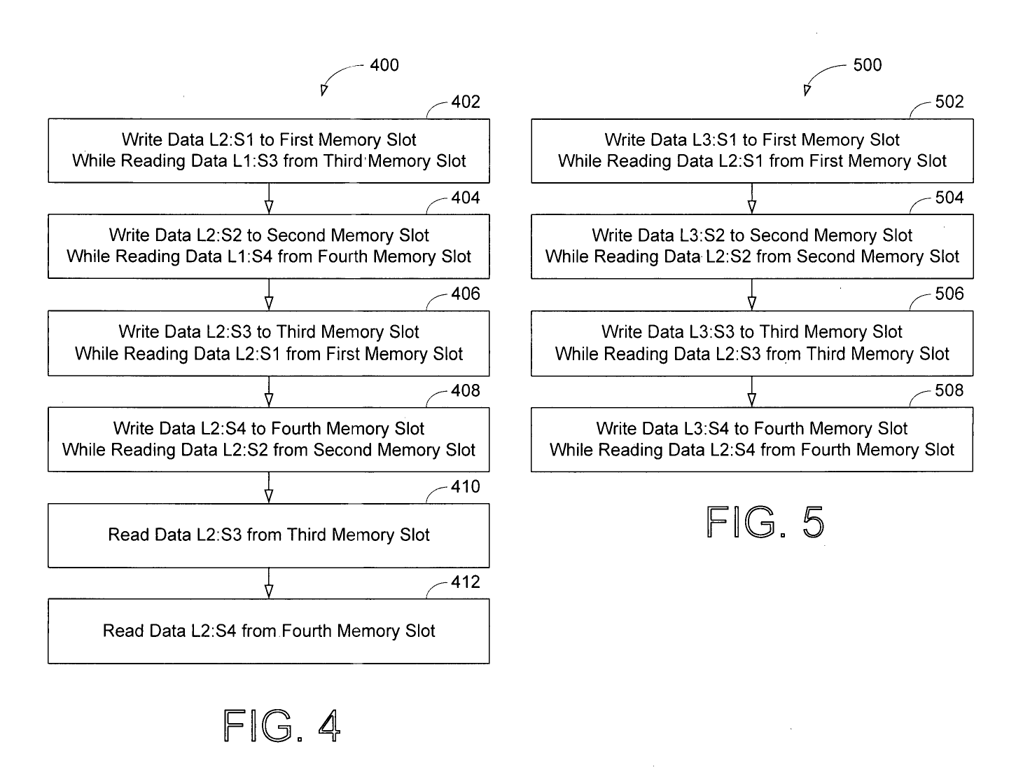

FIG. 4 illustrates method steps in accordance with still another embodiment.

FIG. 5 illustrates method steps in accordance with one embodiment.

### DETAILED DESCRIPTION

Exemplary Memory System

FIG. 1 depicts a memory system 100 in accordance with one embodiment. The memory system 100 includes a write enable demultiplexer 102. The demultiplexer 102 is configured to receive a write enable bus signal 116 and to provide (output) a plurality of write enable signals 106. Further detail regarding the write enable signals 106 will be provided below.

The memory system 100 also includes a serial data demultiplexer 108. The demultiplexer 108 is configured to receive serial data 110 and to assemble that data into parallel form referred to herein as data slices. Such serial data can be provided, for example, in the PCI-Express® format. In one embodiment, each data slice is one hundred twenty-eight bits in width. In another embodiment, other data slices of other corresponding to other data widths (e.g., thirty-two bits wide; sixty-four bits wide, etc.) can also be used. In any case, the demultiplexer 108 is further configured to provide (output) assembled data slices by way of respective data signal paths 112.

The memory system 100 of FIG. 1 also includes memory that is logically partitioned into four memories, or slots, 114. Each memory slot 114 is the width of one data slice as introduced above. As depicted in FIG. 1, each memory slot 114 is one hundred twenty-eight bits wide. Thus, in the context of memory system 100, one data line is defined by four data slices, totaling five hundred twelve bits. Other embodiments having different number of memories slots 114 and/or memories slots 114 of different widths (e.g., sixteen bits, sixty-four bits, etc.) can also be used.

Each of the memory slots 114 is configured to receive data slices from the demultiplexer 108 by way of a corresponding one of the data signal paths 112, and store each data slice on a storage line determined by the write address signal 104. Each write operation is enabled for a particular memory slot 114 by way of the respective write enable signal 106. Thus, each memory slot 114 is defined by several storage lines (i.e., lines, or address) that are individually selectable for data writing operations by way of the write address signal 104 and the corresponding write enable signal 106. It is to be understood that the write address signal 104 is connected and common to each of the memory slots 114. Data slices are selected for reading from each memory slot 114 by way of a corresponding read address signal 118. Such read data is output to a corresponding data bus 120.

As further depicted in FIG. 1, each data bus 120 is coupled to a common bus 122. The common bus 122 of the memory system 100 is five hundred twelve bits wide. Thus, the common bus 122 is capable of receiving data from all four memory slots 114 simultaneously. Data read from a memory slot (or slots) 114 is received into respective buffers 124. Each buffer 124 is one hundred twenty-eight bits wide and operates in a first-in/first-out (i.e., FIFO) manner. In another embodiment (not shown), one or more buffers 124 can be provided that are of another data width (e.g., sixty-four bits wide, etc.).

In turn, each buffer 124 of the memory system 100 corresponds to an egress port 0 through 3 as depicted in FIG. 1. Thus, each buffer 124 is also referred to as a buffered egress port. In one or more other embodiments, the number of buffers 124 can be more or less than the number of memory slots 114. Each of the buffers 124 provides parallel data to one or more recipient components or devices. Each buffer 124 receives one data slice per clock cycle, accumulating and providing entire data lines (i.e., five hundred twelve bits each) by way of the corresponding egress port. Exemplary operations of the buffers 124 are described in further detail below.

The memories slots 114, as depicted in FIG. 1, are referred to as two-port memories because each can be written to and read from at the same time, if desired. However, such simultaneous read-and-write operations necessarily involve different lines, or addresses, within a particular memory slot 114. Exemplary operations of the memory system 100 of FIG. 1, in accordance with the present teachings, are described below in association with Tables 1 and 2.

TABLE 1
First Exemplary Sequence of Operations

| Clock | Slot 0 | Slot 1 | Slot 2 | Slot 3 |
|---|---|---|---|---|
| 1 | Write L1 | Read L0 | No op | No op |
| 2 | Read L1 | Write L1 | Read L0 | No op |
| 3 | Read L2 | Read L1 | Write L1 | Read L0 |
| 4 | Read L3 | Read L2 | Read L1 | Write L1 |
| 5 | Write L2 | Read L3 | Read L2 | Read L1 |
| 6 | Read L2 | Write L2 | Read L3 | Read L2 |
| 7 | No op | Read L2 | Write L2 | Read L3 |
| 8 | No op | No op | Read L2 | Write L2 |
| 9 | Write L3 | No op | No op | Read L2 |
| 10 | Read L3 | Write L3 | No op | No op |
| 11 | No op | Read L3 | Write L3 | No op |
| 12 | No op | No op | Read L3 | Write L3 |
| 13 | Write L4 | No op | No op | Read L3 |

Table 1 above depicts various exemplary data-slice read and write operations of the memory system 100 of FIG. 1. Write operations are underlined for purposes of easier identification and to emphasize the successively advancing nature of writing data slices to the respective memories slots 114. Each read and write operation corresponds to a clock cycle as indicated in the first column of Table 1. For example, during clock cycle “1”, a data slice is written to Line 1 (designated “L1”) of Slot 0, while another, different data slice is simultaneously read from Line 0 (“L0”) of Slot 1. No read or write operations (“No op”) are being performed with respect to Slots 2 and 3 during clock cycle 1. Thus, whatever data slices are stored in Slots 2 and 3 are left undisturbed.

Still referring to Table 1 above, during clock cycle 2 the data slice written to Line 1 of Slot 0 (during clock cycle 1) is read, while the next data slice in that same data line is being written to Line 1 of Slot 1. Also during clock cycle 2, another data slice is being read from Line 0 of Slot 2. Thus, respective read and write operations are occurring simultaneously during clock cycle 2.

Further inspection of Table 1 reveals that four clock cycles (i.e., 1-4) are required to write all four of the data slices common to a particular data line to Line 1 of Slot 0 through Slot 3. Thus, each of these mutually associated data slices resides at the same address within a respective, different memory slot 114. It is also noted that once the last data slice (of that data line) is written at Line 1 of Slot 3 during clock cycle 4, the first data slice of a different data line is written at Line 2 of Slot 0 during clock cycle 5.

Thus, data slices are written to the memory slots 114 in a successive, step-wise manner until an entire data line has been written. Thereafter, the next sequence of write operations begins at the next line of the first memory slot 114 and steps progressively through the three remaining memory slots 114. The overall exemplary sequence of Table 1 is typical of the successively advancing data writing methodology of the present teachings. As such, data slice write operations occur one per clock cycle. In another exemplary operation, a subsequent write operation begins at a line (i.e., address) that is not adjacent or contiguous with the last line used for data writing. Such a data writing sequence can be used, for example, in the context of a “linked list”.

Regarding exemplary read operations, data slices defining a data line (i.e., Line 1) are sequentially read into the buffer 124 of egress port 0 over the course of clock cycles 2 through 5. Similarly, data slices defining data Line 2 are successively read into the buffer 124 of egress port 1 during clock cycles 3 through 6. Furthermore, data slices of data Line 3 are read into buffer 124 of egress port 2 during clock cycles 4 through 7. It is generally noted that respective data slices are simultaneously read into multiple different buffers 124 during several of the clock cycles of Table 1. In this way, data slices can be output by the egress ports at the same average rate that serial data 110 is received at the demultiplexer 108. Another exemplary sequence of operations in accordance with the present teachings is provided by way of Table 2 below.

TABLE 2
Second Exemplary Sequence of Operations

| Clock | Slot 0 | Slot 1 | Slot 2 | Slot 3 |
|---|---|---|---|---|
| 1 | Write L1 | Read L0 | No op | No op |
| 2 | Read L1 | Write L1 | Read L0 | No op |
| 3 | Read L2 | Read L1 | Write L1 | Read L0 |
| 4 | Read L3 | No op | Read L1 | Write L1 |
| 5 | Write L2 | No op | No op | Read L1 |
| 6 | No op | Write L2 | No op | No op |
| 7 | No op | No op | Write L2 | No op |
| 8 | No op | No op | No op | Write L2 |
| 9 | Write L3/Read L2 | No op | No op | No op |
| 10 | Read L3 | Write L3/ | No op | No op |
| | | Read L2 | | |
| 11 | No op | Read L3 | Write L3/Read L2 | No op |
| 12 | No op | No op | Read L3 | Write L3/ |
| | | | | Read L2 |
| 13 | Write L4 | No op | No op | Read L3 |

Inspection of Table 2 above reveals some of the operational elements discussed above with respect to Table 1. However, Table 2 reveals another possible sequence wherein respective data slices are written during clock cycles 5 through 8, yet no data slices are being read during that period. In turn, simultaneous write and read operations are occurring, with respect to a single memory slot 114, during another time period. For example, during clock cycle 9, a data slice is being written to Line 3 of Slot 0, while the data slice stored at Line 2 of Slot 0, during clock cycle 5, is being read.

Other simultaneous write and read operations, involving different lines (i.e., addresses) of the same memory slot 114, are occurring at each of clock cycles 10, 11 and 12. In this way, one full data line is written to memory, while another full data line is read from memory, over the course of four successive clock cycles 9 through 12. Yet another exemplary sequence is provided by way of Table 3 below.

TABLE 3
Third Exemplary Sequence of Operations

| Clock | Slot 0 | Slot 1 | Slot 2 | Slot 3 |
|---|---|---|---|---|
| 1 | Read L1 | Read L10 | No op | No op |
| 2 | No op | Read L1 | Read L10 | No op |
| 3 | No op | No op | Read L1 | Read L10 |
| 4 | Read L11 | No op | No op | Read L1 |
| 5 | Read L2 | Read L11 | No op | No op |
| 6 | No op | Read L2 | Read L11 | No op |
| 7 | No op | No op | No op | Read L11 |
| 8 | Read L12 | No op | No op | No op |
| 9 | No op | Read L12 | No op | No op |
| 10 | No op | No op | Read L12 | No op |
| 11 | No op | No op | Read L2 | Read L12 |
| 12 | Read L13 | No op | No op | Read L2 |
| 13 | Read L3 | Read L13 | No op | No op |
| 14 | No op | Read L3 | Read L13 | No op |

In regard to exemplary Table 3 above, it is assumed that serial data has been received and written to the respect memory slots 114 of FIG. 1. Thus, it is further assumed that write operations are complete for the time period under consideration. Data slices are being read from the memory slots 114 to respective buffers 124 and their egress ports. As shown, data Lines 10, 11, 12 and 13 (i.e., “L10”-“L13”) are understood to be read to a buffer 124 (e.g., egress port 2, etc.) at the same data rate that the serial data 110 was received. Thus, the data slice read operations corresponding to data Lines 10 through 13 are performed in immediate succession over the course of consecutive clock cycles.

In comparison, data Lines 1, 2 and 3 (i.e., “L1”-“L3”) are understood to be read to a buffer 124 (e.g., egress port 0, etc.) at a data rate slower than the rate that the corresponding serial data 110 was received. For example, on clock cycle 6, it is assumed that the buffer 124 of egress port 0 is full and that data reading stops (to that buffer) after the data slice has been read from Slot 1. Data is then spooled (output) from the buffer 124 of egress port 0 during clock cycles 7 through 10. Thereafter, the buffer 124 of egress port 0 resumes receiving data from Slot 2 at clock cycle 11. Such a pause in reading data slices from the memory slots 114 to a buffer 124 will be a number clock cycles equal to an integer multiple of the number of memory slots 114. Thus, the particular sequence that data is read from the memory slots 114 into the buffers 124 can vary in accordance with the data rates at the respective egress ports.

Tables 1, 2 and 3 above exemplify just three of numerous possible operational sequences of the memory system 100 of FIG. 1. Other data slice read and/or write sequences using memory system 100 can also be performed.

Exemplary Methods

FIG. 2 is a flowchart 200 depicting method steps in accordance with one embodiment. While the flowchart 200 illustrates particular method steps and order of execution, it is to be understood that other methods respectively including and/or omitting these and/or other steps can be performed in accordance with the present teachings. Thus, the flowchart 200 is exemplary and non-limiting in nature. The method of the flowchart 200 can be performed, for example, via the memory system 100 of FIG. 1.

At step 202 of FIG. 2, serial data is received and assembled (that is, accumulated and arranged) in parallel form so as to define a first data slice of an overall data line. Thus, the first data slice is a portion of a data line to be progressively defined. For purposes of example, it is assumed that the first data slice is one hundred twenty-eight bits in width. Other data slices of respectively varying data widths can also be assembled and used in accordance with other embodiment under the present teachings.

At step 204, the first data slice is written to a first line, or address, within a first memory slot. For purposes of example, the first line is understood to be defined by a write address signal, and the write operation enabled by a write enabled signal. In any case, the identity of the first line is suitably established prior to, or as needed, to perform the first data slice write operation.

At step 206 of FIG. 2, additional serial data is received and assembled into a second data slice of the data line presently being defined. The second data slice is understood to be of equal data width as the first data slice.

At step 208, the second data slice is written to a first line of a second memory slot. The second memory slot is understood to be logically adjacent to the first memory slot as was written to at step 204 above.

At step 210, the serial data receiving, assembling and writing operations are repeated as needed until the entire data line, as begun in step 202 above, has been written across plural memory slots. For purposes of the present example, it is assumed that third and fourth iterations of receiving, assembling and writing are required in order to store the entire data line. Thus, the exemplary data line is comprised of four data slices of one hundred twenty-eight bits each. The overall data line is five hundred twelve bits wide, and is collectively stored as four data slices at the same line number (address) of the four memory slots. Another iteration of the steps 202-210 can be performed for another data line, wherein the corresponding data slices are written to the next available line number, or to another suitable line number. Thus, data lines that are consecutively assembled may or may not be written to consecutive addresses in memory.

FIG. 3 is a flowchart 300 depicting method steps in accordance with another embodiment. The flowchart 300 is exemplary and non-limiting in nature. The method of the flowchart 300 can be performed, for example, via the memory system 100 of FIG. 1.

At step 302, a first data slice is assembled from received serial data and is written to a first memory slot. The designation “L1:S1” is understood to mean “line one” of “slot one”. The first data slice corresponds to a first data line.

At step 304 of FIG. 3, a second data slice is assembled and written to a second memory slot, at the first line (i.e., address) as the first data slice at step 302 above. Thus, the second data slice is designated “L1:S2”. During the same clock cycle, the first data slice designated “L1:S1” is read from the first line of the first memory slot. Thus, there is simultaneous reading and writing of data slices from the same line of adjacent (different) memory slots.

At step 306 of FIG. 3, a third data slice of the first data line, designated “L1:S3”, is assembled and written to the first line of the third memory slot. During this same clock cycle, the second data slice “L1:S2” is read from the first line of the second memory slot.

At step 308, a fourth data slice designated “L1:S4” is assembled and written to the first line of the fourth memory slot. At the same clock cycle, the third data slice “L1:S3” is read from the first line of the third memory slot. At this point, the entire first data line has been written across the first-through-fourth memory slots, the entire memory width. Furthermore, the first three out of four corresponding data slices have been read from memory.

At step 310, the fourth data slice designated “L1:S4” is read from the first line of the fourth memory slot. Thus, all data slices common to the first data line have been retrieved from memory, and the exemplary method sequence is complete.

FIG. 4 is a flowchart 400 depicting method steps in accordance with another embodiment. The flowchart 400 is exemplary and non-limiting in nature. The method of the flowchart 400 can be performed, for example, via the memory system 100 of FIG. 1. Other suitable means can also be used.

At step 402, a first data slice of a second data line is assembled from received serial data and written to a second line of a first memory slot. This data slice is designated “L2:S1”. At the same clock cycle, a third data slice of a first data line, designated “L1:S3”, is read from a first line of a third memory slot. In this way, there is simultaneous reading and writing of data slices from different lines of different memory slots.

At step 404 of FIG. 4, a second data slice, designated “L2:S2”, is assembled and written to a second line of a second memory slot. During the same clock cycle, a fourth data slice of the first data line designated “L1:S4” is read from the first line of a fourth memory slot. For purposes of this example, it is presumed that the final two data slices of the first data line have been retrieved from memory. In turn, space is now available for storage of other (new) data slices at line of memory slots three and four.

At step 406 of FIG. 4, a third data slice of the second data line, designated “L2:S3”, is assembled and written to the second line of the third memory slot. During the same clock cycle, the first data slice of the second data line “L2:S1”, is read from the second line of the first memory slot.

At step 408, a fourth data slice designated “L2:S4” is assembled and written to the second line of the fourth memory slot. At the same time, the second data slice “L2:S2” is read from the second line of the second memory slot. At this point, the entire second data line has been written across the corresponding memory slots. Also, the first two of four corresponding data slices for the second data line have been read from memory.

At step 410, the third data slice designated “L2:S3” is read from the second line of the third memory slot.

At step 412 of FIG. 4, the fourth data slice of the second data line, as designated “L2:S4”, is read from the second line of the fourth memory slot. Thus, all data slices common to the second data line have been retrieved from memory, and the exemplary method sequence is complete.

FIG. 5 is a flowchart 500 depicting method steps in accordance with another embodiment. The flowchart 500 is exemplary and non-limiting in nature. The method of the flowchart 500 can be performed, for example, via the memory system 100 of FIG. 1. Other suitable means can also be used.

At step 502, a first data slice of a third data line is assembled from received serial data and written to a third line of a first memory slot. This data slice is designated “L3:S1”. Simultaneously, a first data slice of a second data line, designated “L2:S1”, is read from a second line of the first memory slot. In this way, there is simultaneous reading and writing of data slices from different lines of the same memory slot.

At step 504 of FIG. 5, a second data slice, designated “L3:S2”, is assembled and written to a third line of a second memory slot. During the same clock cycle, a second data slice of the second data line designated “L2:S2” is read from the second line of the second memory slot.

At step 506, a third data slice of the third data line, designated “L3:S3”, is assembled and written to the third line of the third memory slot. During the same clock cycle, the third data slice designated “L2:S3” is read from the second line of the third memory slot.

At step 508 of FIG. 5, a fourth data slice designated “L3:S4” is assembled and written to the third line of the fourth memory slot. At the same clock cycle, the second data slice “L2:S4” is read from the second line of the fourth memory slot. At this point, the entire third data line has been written to memory, while the entire second data line has been retrieved (read) from memory. The exemplary sequence of the flowchart 500 is now complete.

The exemplary method steps of the flowcharts 200-500 of FIGS. 2-5 can be executed as shown and as described above. Other operational sequences can be performed, wherein various method steps are selected from the flowcharts 200-500 and executed in other suitable orders. The present teachings foresee nearly limitless sequential combinations wherein serial data is received and stored in memory slots as respective data slices and then read there from.

Furthermore, read operations can occur on the next clock cycle following the writing of a particular data slice, or at some time thereafter. Thus, data can be written across lines of memory for immediate retrieval, stored for extended periods of time for later use, etc. Also, while the examples above depict whole data lines being progressively stored to memory, only the required number of memory slots need be written to. Such as partial data line write operation can occur, for example, when writing the end remainder of a serial data packet to memory. It is to be appreciated that the above-described methods can be implemented in connection with computer-readable instructions that reside on a computer-readable medium and which are executable by a processor to perform the described methods.

### CONCLUSION

The various embodiments described above provide for receiving serial data, assembling that data into parallel forms referred to as data slices, and then storing the data slices in memory slots. The data storage techniques of the present teachings are performed in a successively advancing manner, such that a data slice just written to memory is available for reading on the next clock cycle. Furthermore, data slices previously written to respective memory slots can be read to, and output by, respective buffered egress ports in a simultaneous manner.

The present teachings have been described and exemplified in the context of two-port memories. In another embodiment (not shown), single-port memories can be used, wherein clock cycles are dedicated to write operations and read operations, respectively. In yet another embodiment, double clocking can be used with single-port memories. In such an embodiment, two memory clock cycles occur—one for reading, one for writing—for each primary clock cycle. Other suitable embodiments and methods of operation can also be used.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for handling data, comprising:
receiving serial data;
assembling the serial data into respective data slices; and
writing each data slice to a respective one of several memory slots, the memory slots written to in a successively advancing manner.

2. The method of claim 1 wherein:
a predetermined plurality of the data slices define a data line; and
each of the data slices of the data line are written to same lines within the respective memory slots.

3. The method of claim 1, further comprising outputting the data slices from the respective memory slots by way of one or more buffered egress ports.

4. The method of claim 1, further comprising writing one of the data slices to a line of one of the memory slots while reading another data slice from a different line of another of the memory slots.

5. The method of claim 1, further comprising writing one of the data slices to a line of one of the memory slots while reading another data slice from a different line of the same memory slot.

6. The method of claim 1, further comprising writing one of the data slices to a line of one of the memory slots while reading another data slice from the same line of another of the memory slots.

7. The method of claim 1, further comprising:
assembling some of the serial data into plural data slices of a data line;
writing the data slices of the data line to same line numbers within respective ones of the memory slots;
assembling other of the serial data into plural data slices of another data line; and
writing the data slices of the other data line to other same line numbers within respective ones of the memory slots.

8. A memory system, comprising:
a demultiplexer configured to receive write enable information and to output a plurality of write enable signals;
another demultiplexer configured to receive and assemble serial data into respective data slices;
a memory arranged as a plurality of respective memory slots, each memory slot including plural storage lines and configured to store respective data slices in the storage lines according to an address signal and one of the write enable signals, each memory slot further configured to output respective stored data slices in response to read address signals.

9. The memory system of claim 8 wherein:
a predetermined plurality of the data slices define a data line; and
the memory system is further configured to write the data slices of the data line to same storage lines of the respective memory slots.

10. The memory system of claim 9 wherein the memory system is further configured to write the data slices of the data line to the same storage lines of the respective memory slots in a successively advancing manner.

11. The memory system of claim 8 wherein the memory system is further configured to write one of the data slices to a storage line of one of the memory slots while reading another data slice from a different storage line of another of the memory slots.

12. The memory system of claim 8 wherein the memory system is further configured to write one of the data slices to a storage line of one of the memory slots while reading another data slice from a different line of the same memory slot.

13. The memory system of claim 8 wherein the memory system is further configured to write one of the data slices to a storage line of one of the memory slots while reading another data slice from the same storage line of another of the memory slots.

14. The memory system of claim 8 wherein the memory system is further configured to read one of the data slices from one of the memory slots while reading another data slice from another one of the memory slots.

15. The memory system of claim 8 wherein the memory system is further configured to output the stored data slices by way of one or more buffered egress ports.

16. A method for handling data, comprising:
assembling a stream of serial data into respective data slices, a predetermined number of the data slices defining a data line, the assembling resulting in a plurality of data lines; and
writing each data slice to a respective one of several memory slots, wherein the data slices common to a particular data line are written to a same line number within the respective memory slots, and wherein the data slices are written to the respective memory slots in a successively advancing manner

17. The method of claim 16, further comprising at least one of:
writing a data slice to a respective memory slot while reading another data slice from the same memory slot; or
writing a data slice to a respective memory slot while reading another data slice from another memory slot.

18. The method of claim 16, further comprising outputting the data slices from the memory slots by way of one or more buffered egress ports.

19. The method of claim 18, wherein the stream of serial data is assembled into the respective data slices at a same average rate that the data slices are output by way of the one or more buffered egress ports.

20. A computer-readable storage media including computer-readable instructions, the computer-readable instructions configured to cause one or more processors to perform the method of claim 16.
